(19) United States
(12) Patent Application Publication
(10) Pub. No.: US 2005/0163985 A1
(43) Pub. Date: Jul. 28, 2005

(54) Synergetic SP-SP2-SP3 carbon materials and deposition methods thereof

(76) Inventor: Benjamin F. Dorfman, Potsdam, NY (US)

Correspondence Address: Leslie Gladstone Restaino;Brown Raysman Millstein Felder & Steiner LLP, 163 Madison Avenue, P.O. Box 1989, Morristown, NJ, 07962-1989, US

(21) Appl. No.: 10/970,223

(22) Filed: Oct. 20, 2004

Related U.S. Application Data
(60) Provisional application No. 60/513,468, filed on Oct. 22, 2003.

(51) Int. Cl. B32B 7/02

(52) U.S. Cl. 428/216

(57) ABSTRACT

The present invention generally provides carbon materials and methods for producing the carbon materials that include a polymer-like bonded carbon network, a diamond-like bonded carbon network, a graphene-like bonded carbon network, and at least one stabilizing network of at least one alloying element. The material may further include hydrogen, silicone, and oxygen. The carbon materials are generally produced using plasma deposition while accounting for both thermal and incident particle impact activation for surface reactions, which beneficially enables the production of the carbon material at relevantly low incident flux energy and/or relatively low substrate temperatures.

### RELATED APPLICATIONS

This application claims the benefit of U.S. Provisional Application No. 60/513,468, filed Oct. 22, 2003. This application also incorporates herein by reference U.S. Application Ser. No. ______, entitled HIGH-ALLOY METALS REINFORCED BY DIAMOND-LIKE FRAMEWORK AND METHOD OF MAKING THE SAME, filed on Sep. 22, 2004 under attorney docket 6612/23US.

### BACKGROUND OF THE INVENTION

The present invention relates to dielectric materials. More specifically, the present invention relates to materials that exhibit functional mechanical and dielectric properties.

Progress with regard to integrated circuit (“IC”) technology, as well as many other technologies, dictates a need for conformable materials, including an array of dielectrics, which allow for the formation of a functional IC layer and a matching barrier in a continuous process. There is also a need for materials that exhibit high thermal stability and/or that are capable of being formed into structural components of an IC at relatively low formation temperatures.

It is known that impact activation of chemical reactions using incident fluxes of energized particles may be used to overcome even the highest activation barriers of surface reactions. Using this process, silica stabilized diamond-like carbon was formed on a substrate from siloxane precursors by shooting an ion beam through a siloxane vapor to produce ultra thin silica-stabilized diamond-like carbon films. A remote plasma vacuum CVD (Chemical Vapor Deposition) was used subsequently to deposit relatively thick silica-stabilized diamond-like carbon films using siloxane that possess hardness up to about 50 Gpa. Films possessing the diamond-like properties characterized with superposing C—C diamond-like, Si—C carbide-like and Si—O quartz-like bonds were successfully deposited upon metallic semiconductors, including silicon, germanium, GaAs, GaP, InP, InSb, CdS, CdTe, CdSe, crystalline diamond, and silicon carbide, and various dielectrics that possess single crystalline, polycrystalline, amorphous, and quasi-amorphous structures.

Further development of these approaches resulted in three major families of stabilized amorphous carbon materials that exhibit superior mechanical properties, which may generally be differentiated by their atomic arrangement, their content of doping elements, and by their physical properties, including diamond-like nanocomposites (“DLN”) (also known as Dylyn™) and strongly bonded quasi-amorphous QUASAM™, which are discussed in U.S. Pat. Nos. 5,352,493, 5,466,431, and 6,080,470, each of which is incorporated herein by reference.

The DLN/Dylyn™ material is produced with high-energy incident particles created with an accelerating field under high bias voltage. As a result, it is impractical to produce IC circuits therewith since the energy of the incident particles is likely to damage the surface of a semiconductor substrate as well as sensitive ultra-thin layers and interfaces added thereto. Additionally, the density of films produced using DLN/Dylyn™ technology is relatively high as a result of the high biased accelerating field necessary for deposition. The high density generally limits the k-values of DLN/Dylyn™ materials to a relatively high range, which further limits applicability as a dielectric for ICs. The QUASAM™ material is produced with a relatively high deposition temperature that may similarly damage ultra-thin layers and sensitive interfaces. The relatively high deposition temperature contributes to the materials relatively low resistivity, which further limits applicability of the material as a dielectric for ICs.

There is therefore a need for materials and corresponding methods for producing materials using deposition techniques at lower deposition temperatures while also avoiding the need for high-energy bombardment of the substrate. There is also a need to further decrease the available density and flexibility of amorphous carbon materials, e.g., in the form of films or otherwise, while preserving some or all of the materials mechanical properties.

Recently, various amorphous materials of Carbon-Silicon-Oxygen-Hydrogen have been offered as the most promising low constant (k) dielectrics. Companies such as Novellus Systems, ASM-Japan, Applied Materials, Trikon Technologies, and Mattson Technology manufacture semiconductor equipment (for example, chemical vapor deposition equipment) that can deposit carbon-doped oxides (or “CDO”). The Novellus Systems carbon-doped oxide film is marketed under the trademark CORAL™, the ASM-Japan carbon-doped oxide film is marketed under the trademark AURORA™, and the Applied Materials carbon-doped oxide film is marketed under the trademark BLACK DIAMOND™. The Mattson Technology CDO film is marketed under the trademark GREEN DOT™ and the Trikon Technologies CDO film is marketed under the trademark LOW K FLOWFILL™. All the above companies' approaches are based on doping silicon oxide with carbon or on polymerization of carbon and silicon-containing molecular species.

Although the dielectric properties of these materials may be acceptable for many applications, none of these materials provide a satisfactory combination of mechanical and electrical properties. Another problem with existing low-k dielectric materials is that they tend to absorb moisture, which compromises the performance of films produced therewith. Various approaches have been suggested to overcome this problem, such as by post-processing an implantation to form a shallow compact layer over a dielectric. In this process, shallow implantation is carried out using a relatively high dosage of up to 1016 at/cm² boron ions at an energy level of between about 10 and 50 KeV. Post-process steps, however, generally add to the expense of making thin films.

Recently, Angstrom Systems, Inc. has developed a continuous method for depositing a film with a modulated ion-induced atomic layer deposition (MII-ALD) technique suitable for the deposition of various films including low and high dielectric constant films, which is discussed in U.S. Pat. No. 6,416,822 that is hereby incorporated herein by reference. Angstrom Systems proposes deposition reaction primarily via substrate exposure to impinging ions where the ions are used to deliver the necessary activation energy to the atoms near the surface of the substrate and any adsorbed reactants via collision cascades.

Also recently, IBM has developed low k dielectric materials with an inherent copper ion migration barrier, which is discussed in U.S. Pat. No. 6,414,377 that is hereby incorporated herein by reference. This reference discusses an interlayer dielectric for preventing Cu ion migration in a semiconductor structure. However, the dielectric is produced using a hazardous additive, such as sulfur compounds, sulfide compounds, cyanide compounds, multidentate ligands, or polymeric compounds.

### SUMMARY OF THE INVENTION

The present invention generally provides a new class of material or materials, e.g., synergetic carbon material, that are produced in a manner accounting for both thermal and incident particle impact activation for surface reactions, which beneficially enables the production thereof using deposition techniques that involve relatively low flux energy for the constituent elements flow and/or relatively low substrate temperatures, which may be used, e.g., to produce ultra-low stress films and coatings. The materials of the present invention generally possess a low or ultra-low density with respect to their mechanical properties and a relatively low dielectric constant, as well as other beneficial properties. The structure and, correspondingly, the mechanical and/or the electrical properties of the materials produced in accordance with the present invention are generally achieved by varying the deposition conditions.

In one embodiment of the invention, a new class of materials is provided that includes polymer-like carbon-carbon chains incorporated into a diamond-like carbon matrix. These types of materials generally exhibit a combination of flexibility and wear resistance. In another embodiment, a class of polymer-like carbon material is provided that includes or incorporates therein a diamond-like network that serves to reinforce and/or harden the material. In another embodiment of the invention, a material is provided that integrates diamond-like and polymer-like bonded carbon networks in approximately equal proportions. In yet another embodiment, the material also includes a variable portion of a graphene-like sp² bonded carbon constituent. In this instance, the graphene-like sp² bonded carbon serves to further reinforce the material's structure and to increase its fracture toughness. The synergetic carbon structure of the new materials may also be stabilized by incorporating therein a network of alloying elements or compounds, such as silicon, hydrogen, and oxygen.

In another aspect of the invention, methods for producing or otherwise fabricating the materials disclosed herein are provided that combine or account for both thermal and incident particle impact activation of surface reactions to produce the material with constituent elements activated in the lowest active ranges of incident flux energy and substrate temperature. The method may be accomplished in a variety of ways. Three deposition techniques for producing the materials of the present invention are presented for illustrative purposes, including 1) a remote plasmatron source of flux of constituent elements, 2) magnetron spattering, and 3) direct plasma discharge into the deposition area.

With the remote plasmatron, the location of the substrate outside of the plasma discharge makes it especially valuable for sensitive substrates and devices, and also provides the maximum variability for the deposition process. Magnetron spattering techniques present the most feasible approach for a standard technology for producing the material of the present invention insofar as deposition that may be applied with small variation for different applications. Direct plasma discharge into the deposition area provides the most productive base for deposition technology. Each of these methods possesses certain advantages and limitations, and appropriate selection of the most feasible method depends on specific requirements of respective applications.

In another aspect of the invention, a class of sp-sp²-sp³ synergetic carbon materials is provided that is formed from interpenetrating diamond-like, graphene-like, and polymer-like bonded carbon networks. The synergetic carbon materials contain hydrogen and at least one stabilizing network made from at least one alloying element. In another aspect of the invention, a class of sp-sp²-sp³ synergetic carbon materials is provided that is formed from interpenetrating diamond-like, graphene-like, and polymer-like bonded carbon networks, hydrogen, and at least one stabilizing network made from alloying elements of silicon stabilized by oxygen.

In another aspect of the invention, a method for fabricating or otherwise producing a class of hard carbon materials is provided by depositing a low-energy accelerating flow of ions, atoms, and radicals of constituent elements onto a substrate. The constituent elements may be generated using at least one remote plasma generator and/or at least one magnetron, preferably an RF planar magnetron with target material containing at least one constituent element. The constituent element may be generated while locating the substrate in the plasma discharge in a low-pressure gas flow.

In another aspect of the invention, a carbon material is provided that includes a plurality of interpenetrating carbon networks including a polymer-like bonded carbon network, a diamond-like bonded carbon network, a graphene-like bonded carbon network, and at least one stabilizing network of at least one alloying element. In one embodiment, the carbon networks are partially inter-bonded together. The material may be stabilized with a variety of elements, such as silicon stabilized by oxygen. Similarly, the material may include various alloying elements, such as hydrogen, oxygen, and silicon.

In one embodiment, the carbon material is produced by depositing constituent elements on a substrate using a deposition technique that produces a flow of constituent elements, including carbon, in a form of at least one of ions, atoms, and radicals, where at least 55 atomic % of carbon in the flow has an energy in the range of from about 10 eV to about 95 eV, and the substrate is maintained at a temperature less than 300 degrees C.

In another aspect of the invention, a carbon material is provided that includes a polymer-like bonded carbon network, a diamond-like bonded carbon network, and a graphene-like bonded carbon network, hydrogen, and at least one stabilizing network of at least one alloying element. In this instance, the carbon networks interpenetrate each other and are partially inter-bonded, and the material includes at least 10% diamond-like bonded carbon and at least 5% polymer-like bonded carbon.

In another aspect of the invention, a method for producing a carbon material is provided by depositing on a substrate constituent elements using a deposition technique that provides a flow of constituent elements, including carbon, in a form of at least one of ions, atoms, and radicals, where at least 55 atomic % of carbon in the flow has an energy in the range of from about 10 eV to about 95 eV, while maintaining the substrate at a temperature less than 300 degrees C. during deposition. In one embodiment, the carbon material includes carbon, silicon, oxygen, and hydrogen as constituent elements that are derived from a polysiloxane precursor.

Additional aspects of the present invention will be apparent in view of the description which follows.

### BRIEF DESCRIPTION OF THE FIGURES

FIG. 1 is a graph showing a range of the deposition condition parameters: substrate temperature and average flux energy, using a deposition processes to produce the material according to at least on embodiment of the present invention.

FIGS. 2a-2c are diagrams showing the difference in symmetry (predominant orientation of respective carbon-carbon bonds) of the carbon constituents of the material according to at least one embodiment of the present invention in comparison with that of QUASAM™ and DLN/Dylyn™. The asymmetry (anisotropy) of the respective carbon constituents is magnified in these schematic diagrams for illustrative purposes.

FIG. 3 is a graphical representation showing the difference in the composition of the stabilized synergetic carbon family of materials according to at least one embodiment of the present invention from QUASAM™, DLN/Dylyn™, and other forms of non-crystalline carbon-based materials, including various low-k dielectrics, such as SILK™ by Dow Chemical, Black Diamond™ by Applied Materials, and Coral™ by Novellus Systems.

FIG. 4 is a graph showing the experimental plot of the density of the material according to at least one embodiment of the present invention vs. the bias voltage used to produce the material according to at least one embodiment of the invention.

FIG. 5 is a diagram of a vacuum deposition system with a remote plasmatron for use in producing the material according to at least one embodiment of the present invention.

FIG. 6 is a diagram of a vacuum deposition system for use in producing the material according to at least one embodiment of the present invention.

FIG. 7 is a diagram of a plasma vacuum CVD with low pressure gas flow for use in producing the material according to at least one embodiment of the present invention.

### DETAILED DESCRIPTION OF THE INVENTION

The term Stabilized Synergetic Carbon or SSC as used herein generally refers to amorphous carbon materials that include a synergetic structure of any combination of the three major carbon bonds “polymer-like” sp bonds predominantly oriented along the film growth direction, i.e., in normal direction to the substrate surface, “graphene-like” sp² bonds predominantly oriented in the parallel, to the substrate directions, and a three dimensional network of “diamond-like” sp³ covalent bonds, stabilized by silica or silicon, while the silica is the most preferable stabilizing component, or otherwise.

There are two families of undoped SSC materials known in the art, which are differentiated with their atomic arrangement and correspondingly by physical properties. QUASAM™, for instance, has a density typically within the range of 1.35 to 1.75 g/cm³. With regard to the atomic arrangement, QUASAM™ materials possess a quasi-periodic hierarchical structure where graphene planes are bonded together with a diamond-like three-dimensional network that penetrates the entire diamond-graphene structure. Additionally, a silica network is strongly bonded with the carbon network. QUASAM™ Materials possess slight one-axis anisotropy. DLN/Dylyn™ in contrast has a density typically within the range of 2.1 to 2.23 g/cm³. In DLN/Dylyn™ the diamond-like network, the graphene planes, and the silica network are only partially bonded, and the entire structure is completely amorphous. Both graphene-diamond-like synergetic carbon materials QUASAM™ and DLN/Dylyn™ consist of carbon, silicon, oxygen, and a variable content of hydrogen.

Undoped QUASAM™ and DLN/Dylyn™ are generally pore-free dielectric dielectrics. They possess excellent barrier properties against water, vapor, and penetration of various aggressive chemicals, and also excellent barrier properties against metal diffusion at least up to 600 to 800 degree C.

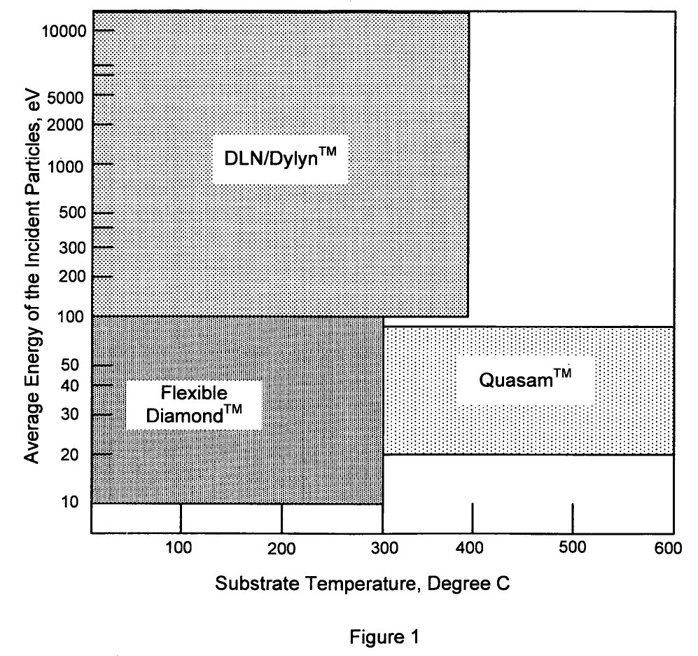

The present invention generally provides a new family of materials, SSC or otherwise, and methods for producing the same. In one embodiment, the material of the present invention is produced in accordance with a process that uses or takes into account both thermal and impact activation for activating the chemical reactions for the material being synthesized. Accounting for the thermal activation decreases both the substrate temperature and the impact (accelerated or incident flux) energy necessary to produce the material. Various methods may be used to account for thermal activation, such as by using chemical reactions that activate at lower temperatures thus requiring less impact activation energy. Preferably, the material of the present invention is produced by depositing a flow that includes constituent elements, including ions, atoms, and radicals thereof, onto a substrate where at least 55 atomic % of carbon particles in the flow have an energy in the range of from about 20 to about 95 eV, while maintaining the temperature of the substrate during fabrication to less than about 300 degrees C. The range of incident flux energy of the constituent elements and substrate temperature for the material of the present invention are shown in FIG. 1 along with that of DLN/Dylyn™ and QUASAM™ for comparison. This aspect of the invention beneficially allows for the deposition of SSC and doped SSC with pre-defined electrical, mechanical, as well as other properties, using less energy and using a process less prone to cause damage to sensitive structures, e.g., with relatively high radiation and substrate temperatures.

The present invention also generally provides atomic-scale composite materials that incorporate therein sp³, or diamond-like, bonded carbon atoms, and sp, or polymer-like, bonded carbon atoms, and, in one embodiment, sp², or graphene-like, bonded carbon atoms. In one embodiment, the composites of the present invention are stabilized with one or more alloying elements, such as silicon, oxygen, and hydrogen. The polymer-like constituent of the material generally increases flexibility and also decreases the stress, e.g., internal stress, associated with stabilized amorphous carbon. The material of the present invention may equally be viewed as a polymer, e.g., a silicon-organic polymer, reinforced and hardened with a diamond-like constituent. The material of the present invention may also exhibit a plurality of the following properties: relatively high values of hardness, e.g., 10 GPa or greater, elastic modulus, e.g., 50 GPa or greater, fracture toughness, thermal stability with ultra-low density, exceptionally low stress, and useful electrical properties especially valuable for low-k dielectric applications, e.g., dielectric constant of 10.0 or less. These materials will also be referred to herein as Flexible Diamond™.

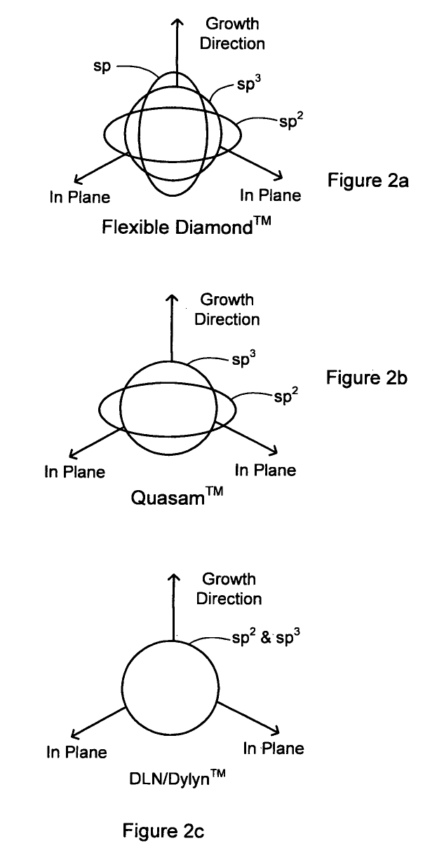

In another embodiment of the present invention, a new class of synergetic carbon materials formed, in particular sp-sp²-sp³ formed from interpenetrating diamond-like, graphene-like, and polymer-like bonded carbon networks with sp bonds oriented predominantly or essentially along the direction of growth. Thus, the constituent carbon networks possess different symmetry: sp bonds possess a distinguished axis along the direction of growth, sp² bonds are oriented predominantly or essentially in plane, while the sp³ bonds are not so limited, as shown in FIG. 2. This predominant symmetry is expressed slightly in the structure of the SSC material, which is opposite to that of crystalline structures where every constituent bond possesses a strongly defined orientation. Still, orientation may be important for some properties, especially mechanical properties such as fracture toughness, flexibility, as well as thermal conductivity.

FIG. 2 shows the difference in symmetry (predominant orientation of respective carbon-carbon bonds) of carbon constituents for the material of the present invention as well as that of QUASAM™ and DLN/Dylyn™. For illustration, the asymmetry (anisotropy) of the respective carbon constituents is magnified in these schematic diagrams. In reality, the anisotropy is slighter, although the extent depends on the specific conditions for the particular material synthesis.

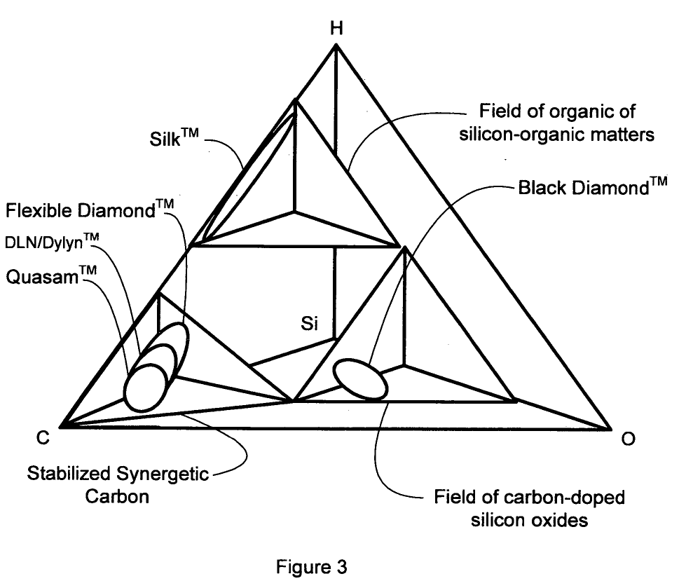

In one embodiment, the material of the present invention includes the element hydrogen therein. Accordingly, the hydrogen content in the material of the present invention further differentiates it from other known amorphous carbon or carbon doped materials. In one embodiment, the content of hydrogen exceeds that of DLN/Dylyn™ and QUASAM™. FIG. 3 illustrates the relative difference in composition of Stabilized Synergetic Carbon family of materials including Flexible Diamond, QUASAM™, and DLN/Dylyn™ and other forms of non-crystalline carbon-based materials, including various low-k dielectrics. For illustration, the industrial materials SILK™ by Dow Chemical, Black Diamond™ by Applied Materials, and Coral by Novellus Systems are also shown.

In another embodiment of the invention, a class of sp-sp²-sp³ synergetic carbon materials is provided that are formed from interpenetrating diamond-like, graphene-like, and polymer-like bonded carbon networks, which contain hydrogen and at least one stabilizing network made from at least one alloying elements, such as oxygen, silicon, etc. In one embodiment, the material is at least partially amorphous or wholly amorphous. In this instance, the carbon networks are partially inter-bonded together, the content of sp³ bonded diamond-like carbon constituent of the material is at least 10% of total carbon content, but preferably it is at least 25% of total carbon content, the content of sp bonded polymer-like carbon constituent of the material is at least 5% of total carbon content, but preferably it is at least 15% of total carbon content, and the content of sp² graphene-like constituent of the materials is the rest of the material's total carbon content. The density of this material in general is in the range of about 1.1 g/cm³ to about 1.7 g/cm³. The content of the sp bonded polymer-like carbon constituent may generally be increased to reduce the density and increases the flexibility of the material. In another embodiment, the content of sp bonded polymer-like carbon constituent of the material of the present invention is about or above 20% of total carbon content and the material possesses a density of about or below 1.6 g/cm³. In another embodiment, the content of sp bonded polymer-like carbon constituent of the material is about or above 30% of total carbon content and the material possesses a density of about or below 1.5 g/cm³. In at least one embodiment, the material of the present invention includes at least one stabilizing network made from alloying elements, such as silicon stabilized by oxygen.

In one embodiment, the sp-sp²-sp³ synergetic carbon material of the present invention further has a carbon content of at least 25 atomic % of the sum of carbon and the other alloying elements, while preferably the carbon content of the materials is at least 33 atomic % of the sum of carbon and the other alloying elements, and still more preferably the carbon content of the materials is in the range of about 67 to about 75 atomic % of the sum of carbon and the alloying elements. Similarly, in one embodiment, the sum concentration of the alloying elements, except for hydrogen, is in the range of about 10 to 75 atomic % of the sum of carbon and the alloying elements, but preferably it is in the range of 25 atomic % to 33 atomic % of the sum of carbon and the alloying elements, and the hydrogen content is at least 10 atomic % of the carbon concentration, but preferably it is about or above of 50 atomic % of the carbon concentration.

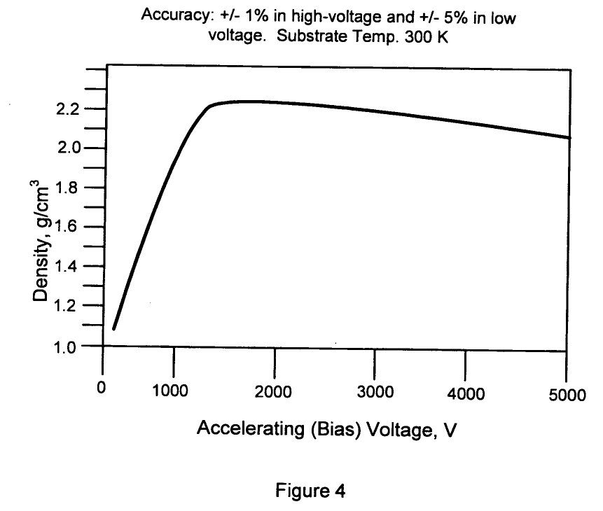

The materials of the present invention generally possess an ultra-low density, e.g., no greater than 1.7, with respect to their mechanical properties and a relatively low dielectric constant k, e.g., of about or below 5.0, or preferably about or below 3.0 at a frequency of about 100 kHz, as well as other desirable properties. This material's density is also generally based at least in part on the incident particle energy, which depends on the accelerating (bias) voltage during the material deposition. FIG. 4 shows the experimental plot of density vs. bias voltage. The accuracy in the vicinity of maximum is +/−1% at the high-voltage and at the low-voltage extremity of the plot it is about +/−5%. Substrate temperature during the deposition processes in this plot is 300 K. It can be seen that material density as low as 1.1 g/cm³ may be achieved at low accelerating voltage which is achievable with the methods for producing the material of the present invention.

The advantages of the materials of the present invention with respect to the SSC technology know in the art are illustrated below in Table A.

TABLE A

| DLN/Dylyn ™ | QUASAM ™ | Flexible Diamond ™ |
|---|---|---|
| High energy incident particles | The deposition temperature is | The incident particle energy |
| produced with an accelerating | relatively high, which limits | necessary to produce the |
| field under high bias voltage, | applications of the technology, | material is below of threshold |
| which may damage the surface | especially incorporating the | for structurally damaging |
| of semiconductor and sensitive | ultra-thin layers and sensitive | collisions |
| ultra-thin layers and interfaces | interfaces | |
| The film density is relatively | Due to the relatively high | The substrate temperature is |
| high due to the high | deposition temperature, the film | below 300 degree C. |
| accelerating field, which | resistivity may be limited in a | |
| restricts the available k-values | relatively low range | |
| of dielectric films in a relatively | | |
| high range | | |
| | | The material density may be as |
| | | low 1.1 g/cm³ |
| | | Possesses combination of |
| | | various properties, such as |
| | | dielectric constant, hardness, |
| | | and modulus |
| | | Low-voltage low-temperature |
| | | technology expands areas of |
| | | SSC applications, including |
| | | coatings for plastics, flexible |
| | | electronics, flat panel displays |
| | | on plastic substrates, etc. |

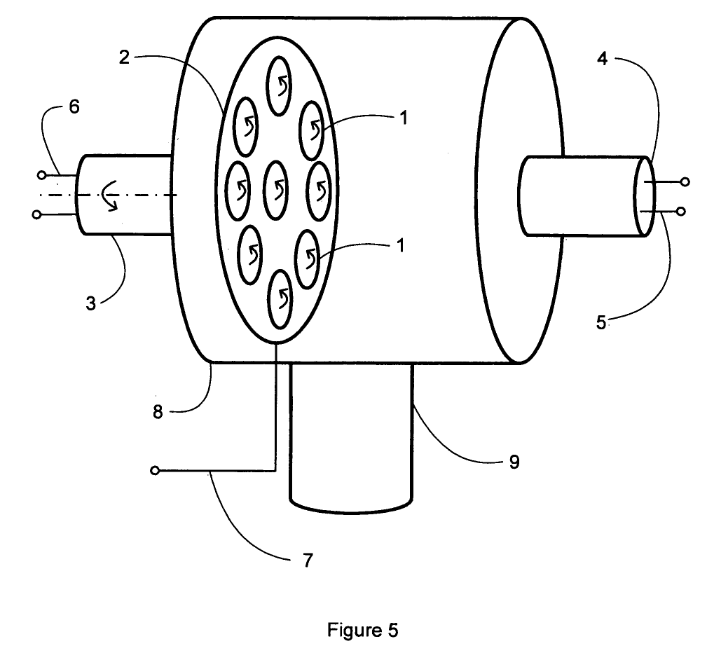

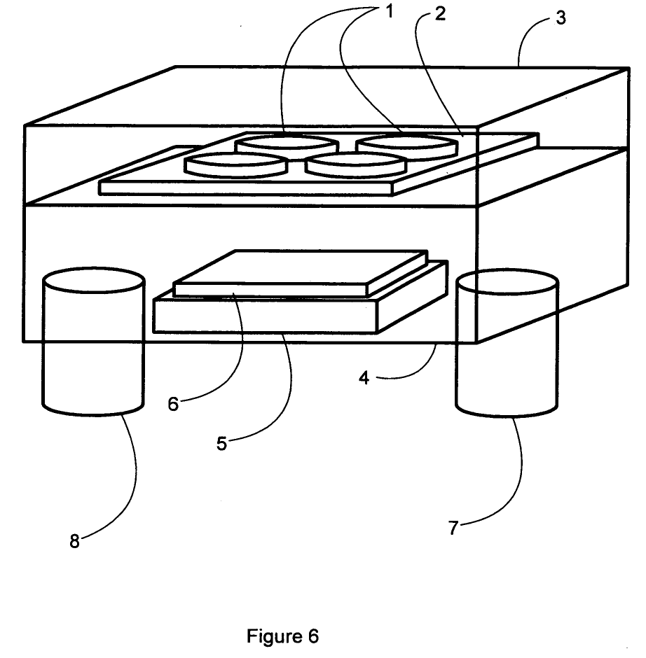

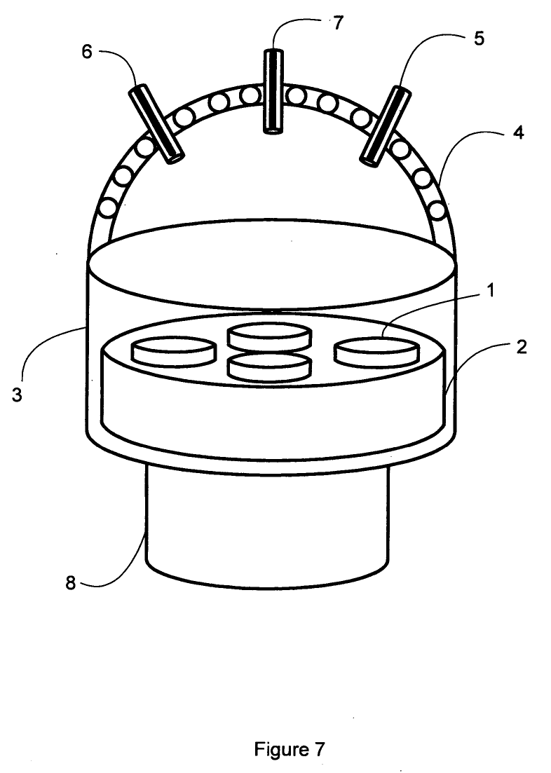

From the disclosure above, it can be seen that the methods for fabricating the materials of the present invention may be realized by combining both thermal and incident particle impact activation of surface reactions to produce materials in the lowest active ranges of constituent element energy incident flux and at low substrate temperatures. Accordingly, the materials of the present invention may be fabricating using various deposition techniques that allow or provide for the combination of thermal and incident particle impact activation of chemical reactions, such as with a remote plasmatron (FIG. 5) technique, a magnetron (FIG. 6.) spattering technique, a direct plasma discharge (FIG. 7) technique, etc. These systems generally provide a source of flux or flow containing constituent elements for deposition.

With the remote plasmatron, the location of the substrate is generally located outside of the plasma discharge, which is especially valuable for sensitive substrates and structures, and also provides the maximum variability for the deposition process. Magnetron spattering deposition techniques present the most feasible approach for a standard technology to produce the material of the present invention since spattering may be variably applied for different applications. Direct plasma discharge techniques are the most productive base for deposition technology, although the available range of variation of conditions of the synergetic carbon formation in some cases may be limited.

More specifically, the following methods of new materials synthesis are provided herewith. In one embodiment, a method for fabricating a class of hard carbon materials is provided that includes the steps of depositing constituent elements, such as I the form of ions, atoms, and radicals thereof, onto a substrate while maintaining the temperature of the substrate during fabrication up to about but not exceeding 299 degrees C. or otherwise less than 300 degrees C., preferably, no more than 275 degrees C., and more preferably no more than 100 degrees C. In this instance, the constituent elements are deposited by placing the substrate in a flow or flux of constituent elements where at least 55 atomic % of carbon particles in the flow have an energy in the range of from about 10 to about 95 eV. Preferably, at least 95% of incident carbon-containing particles in the flux possess energy in the range of 10 to 85 eV.

The flow or flux of constituent elements may be generated using at least one remote plasma generator that locates the substrate, as the name implies, remote from the plasma source. A variety of precursors may be used to supply the constituent for the reaction, such as polysiloxane, which provides the constituent elements carbon, silicon, oxygen, and hydrogen. The polysiloxane generally has a high-temperature boiling point, which may be supplied as a liquid that is vaporized in the plasmatron. It is understood that the precursor may be supplied as a gaseous compound or compounds. For instance, a silicon-organic gaseous compound may be used for the precursor to provide the constituent elements for material deposition. A single precursor may supply all of the constituent elements or a plurality of precursors may supply the constituent elements, e.g., individual gaseous compounds may be used as precursors for the respective constituent elements.

In another embodiment, the material of the present invention is formed on a substrate using at least one remote plasma generator while maintaining the pressure in the deposition chamber at a level of about or below 1 millitorrs, preferably of about or below 0.3 millitorrs. In another embodiment, the material is formed on a substrate using a direct plasma discharge apparatus that locates the substrate in a low-pressure gas flow plasma discharge, while maintaining the pressure in the deposition area at a level of at least 3 millitorrs, preferable in the range of about 10 to 100 millitorrs or above.

The material of the present invention may also be generated using at least one magnetron, preferably an RF planar magnetron with a target material containing at least one of constituent element. The target material may be, for example, a solid silicon-organic compound that serves as the precursor for the constituent elements, such as carbon, silicon, oxygen, and hydrogen. A plurality of magnetrons may also be used to provide the constituent elements for deposition, such as at least one magnetron with a carbon-containing target and at least one magnetron with a silicon or silicon oxide containing target.

In one embodiment, the SSC material or films are typically deposited with a flux of a carbon-containing radical. Although, different SSC deposition processes are possible, including but not limiting co-deposition from multiple atomic and/or molecular fluxes containing the individual elements or low-molecular species of carbon, silicon, and other constituting elements. A radical beam may be generated with a multi-cascade remote plasmatron (4) using, e.g., the high boiling point silicon-organic precursor (CH₃)₃SiO[CH₃C₆H₅SiO]₃Si(CH₃)—polymethyl-phenyldisiloxane (M=571.05, LgP=15.0-5700T-1, Pa). This is the preferred precursor for certain embodiment of the present material to produce stabilized diamond-like carbon due to its physical-chemical properties, such as optimum C/(Si+O) ratio and relatively low hydrogen content. The general chemical composition of silica-stabilized diamond-like carbon films grown from polymethyl-phenyldisiloxane is: Cₙ[Si₁₋ₘOₘ], where typically n=3, m=0.45, and sp²:sp³ is in the range of 2:3 to 1:4 depending on growth conditions.

Referring to FIG. 5, the silicon-organic liquid or gas is generally supplied through a microporous ceramic head located in the geometric center of the plasma discharge (not shown). The remote plasma discharge may be generated using a W-Th hot filament and crossing two electrical fields: low voltage D.C. (radial) and high voltage RF or DC (axial). The low voltage (typically ˜100 V) D.C. field is generally located in the internal plasmatron space 4 and the high voltage bias field crosses the entire chamber space 4, 8. The filament temperature is generally in the range of 2900K+/−100K, and an estimate for the ratio of electron emissions to the precursor vapor flow is 102 electrons/molecule. During the deposition process, the substrates 1 may be located on a planetary rotating substrate holder 2. To provide the most uniform atomic-scale and/or nano-scale pore distribution, it is especially effective to use an electrical-magnetic high-speed drive for the substrate holder. Equipping the deposition chamber with double-rotating planetary substrate holders, although not essential for the present invention, is useful for film uniformity.

The remote plasmatron generally includes a deposition chamber 8 with a substrate holder 2 therein that supports deposition substrates 1. Holder 2 may rotate via a drive 3 and a planetary drive may also rotate the individual substrates 1 within holder 2. Holder 2 may also be equipped with a heater (not shown) to heat substrates 1 prior to and during deposition. In one embodiment, piping couples the deposition chamber 8 to mechanical and/or diffusion pumps (not shown) for creating and maintaining a vacuum during deposition. Plasmatron 4 is disposed, e.g., within a wall, opposing the sample holder 2. The plasmatron 4 is connected to power supplies (not shown).

In at least one embodiment, the deposition flux directed to the samples 1 on holder 2 is uniform across the entire diameter or area of holder 2. Rotation of the holder 2 combined with the rotation of individual substrates 1 may be used to maintain uniform deposition within the substrates. Precursor flow (that supplies carbon, silicon, hydrogen, and/or oxygen species) is coupled to or fed into the plasmatron 4 to supply the species for the constituent elements. Fluxes from the plasmatron 4 may be started and stopped by toggling electrical power to the plasmatron and magnetron.

In one embodiment, the remote plasmatron has a deposition chamber 8 with an internal or inside diameter of about 1000 mm, at least one 950-mm double-rotating planetary substrate holder 2, a central plasmatron 4 that has an inside diameter of 250 mm, a plurality, e.g., three, peripheral plasmatrons with an inside diameter of 160 mm each (not shown), and three planar magnetrons with an inside diameter of 160 mm each (not shown). The peripheral plasmatrons and/or magnetrons may be located concentrically with regard to a central major plasmatron.

With regard to the magnetron spattering technique, the target material may be a composite, assembly, or solid silicon-organic material or materials that include the constituent elements. In one embodiment, the solid silicon-organic materials are dielectrics and the composite target is dielectric or high-resistivity matter. In this instance, the material produced therewith is an assembly that combines the different components of both these types of materials. The preferred technique for spattering such materials is with the use of high-frequency magnetrons.

The precursors for the constituent elements may be individual carbon-hydrogen compounds, silicon-hydrogen compounds, and oxygen, or gaseous silicon-organic compounds. A non-inclusive list of compounds that may be used as precursors to provide the desired constituent element or elements in addition to those discussed above is provided below in Table B.

The present invention is described in the following Example, which is set forth to aid in the understanding of the invention, and should not be construed to limit in any way the scope of the invention as defined in the claims which follow thereafter.

### EXAMPLE

A remote plasmatron was used to deposit a film of the present invention onto a substrate. The cathode current used was in the range of 60 to 70 A, while 65 A is typical. The plasma current used was in the range of 3 to 7 A, while 5 A is typical. The distance from the cathode to the substrate used was in the range of 10 to 30 cm, while 12 cm is typical. The initial flow rate of the liquid precursor (polysiloxane) was in the range of 2 to 6 ml/hour, while 3 ml per hour is a typical value. The pressure in the deposition chamber was maintained initially (prior to deposition process) at 1.3×10⁻² Pa. and during deposition at 5×10⁻² Pa. Note, the initial flow rate of liquid precursor may be in the range of 6 to 10 ml per hour or higher to achieve a proportionally higher growth rate of SSC material; however, this flow rate may not be preferable for depositing thin dielectric layers. The accelerating (bias) voltage precursor was 50 V (+/−5%), frequency was 13.56 MHz, and thee substrate temperature was maintained at 225 degrees C. (+/−5%). The deposition rate achieved was about 5.4 micrometers/hour (1.5 nm/second) at the typical values of the above-indicated parameters. The material produced has a density of about 1.50 g/cm³, a dielectric constant k about 3.0, and elastic modulus of about 80 Gpa, and a hardness of about 12 GPa.

TABLE B

| | | Boiling |
|---|---|---|
| Name | Formula | point (° C.) |
| Propanol3-trymethylsilyl | C₆H₁₆OSi | 141 |
| Silacyclohexane | C₁₇H₂₀Si | 193 |
| Diethyldiethoxysilane | C₆H₁₆O₂Si | 114 |
| Diphenyldiethoxysilane | C₆H₂₀O₂Si | 167 |
| Diethoxymethylphenylsilane | C₁₁H₁₈O₂Si | 218 |
| Allydiethoxymethylsilane | C₆H₁₈O₂Si | 155 |
| Diemethoxydimethylsilane | C₄H₁₂O₂Si | 82 |
| Diemethoxydiphenylsilane | C₁₄H₁₈O₂Si | 161 |
| Diphenoxydimethylsilane | C₁₄H₁₈O₂Si | 130 |
| Ethenyldiethoxymethylsilane | C₇H₁₆O₂Si | 133 |
| Ethenylethoxydimethylsilane | C₆H₁₄OSi | 99 |
| Ethenyltriethoxysilane | C₈H₁₈O₃Si | 68 or 148 |
| Ethoxytriethylsilane | C₈H₂₀OSi | 154 |
| Ethoxytrimethylsilane | C₅H₁₄OSi | 76 |
| Ethoxytriphenylsilane | C₂₀H₂₀OSi | 344 |
| Ethyltrimethoxysilane | C₅H₁₄O₃Si | 124 |
| Methyltriphenoxysilane | C₁₉H₁₈O₃Si | 269 or 210 |
| 1,3-phenylenebis(oxy)bistrimethylsilane | C₁₂H₂₂O₂Si₂ | 240 |
| Phenytripropylsilane | C₁₅H₂₆Si | 146 |
| Tetravinylsilane | C₈H₁₂Si₂ | 130.2 |
| Tetraethylsilane | C₆H₂₀Si | 154.7 |
| Tetramethylsilane | C₄H₁₂Si | 26.6 |
| Tetraphenylsilane | C₂₄H₂₀Si | 228 |
| Tributylsilane | C₁₂H₂₈Si | 221 |
| Tributylphenylsilane | C₁₈H₃₂Si | 140 |
| Triethoxysilane | C₆H₁₆O₃Si | 123.5 |
| Triethoxyethylsilane | C₈H₂₀O₃Si | 158.5 |
| Triethoxymethylsilane | C₇H₁₈O₃Si | 142 |
| Triethoxypenthylsilane | C₁₁H₂₆O₃Si | 95 |
| Triethoxyphenylsilane | C₁₂H₂₀O₃Si | 112 |
| Triethoxy-2-propenylsilane | C₉H₂₀O₃Si | 100 |
| Triethylsilane | C₆H₁₆Si | 109 |
| Triethylfluorosilane | C₆H₁₅FSi | 110 |
| Triethylphenylsilane | C₁₂H₂₀Si | 236 |
| Trifluorophenylsilane | C₆H₅F₃Si | 101.5 |
| Trimethoxymethylsilane | C₄H₁₂O₃Si | 102.5 |
| Trimethoxyphenylsilane | C₉H₁₄O₃Si | 130 |
| Trimethylsilane | C₃H₁₀Si | 6.7 |
| Trimethyl-4-methylphenylsilane | C₁₀H₁₆Si | 192 |
| Trimethyl-2-methypropylsilane | C₇H₁₈ Si | 108.5 |
| Trimethylphenoxylsilane | C₉H₁₄OSi | 119 |
| Trimethylphenylsilane | C₉H₁₄Si | 169.5 |
| Trimethylphenylmetthylsilane | C₁₀H₁₆Si | 190.5 |
| Trimethyl-2-propenylsilane | C₆H₁₄Si | 86 |
| Trimethylpropylsilane | C₆H₁₆Si | 89 |
| Trimethyl-4-trimethylsilyloxyphenylsilane | C₁₂H₂₂OSi₂ | 132 |
| Silanetriol, ethenyl, triacetate | C₈H₁₂O₆Si | 115 |
| Silanetriol, methyl, triacetate | C₇H₁₂O₆Si | 110 |
| Tripropylsilane | C₉H₂₂Si | 172 |
| Dimethyl ethyl silanol | C₄H₁₂OSi | 120 |
| Methyldiphenyl silanol | C₁₃H₁₄OSi | 184 |
| Triethylsilanol | C₆H₁₆OSi | 154 |
| Triephenylsilanol | C₁₈H₁₆OSi | |

While the foregoing invention has been described in some detail for purposes of clarity and understanding, it will be appreciated by one skilled in the art, from a reading of the disclosure, that various changes in form and detail can be made without departing from the true scope of the invention in the appended claims.

1. An atomic scale composite carbon material comprising a plurality of interpenetrating carbon networks comprising a polymer-like bonded carbon network, a diamond-like bonded carbon network, a graphene-like bonded carbon network, and at least one stabilizing network of at least one alloying element.

2. The carbon material of claim 1, wherein the carbon networks are partially inter-bonded together.

3. The carbon material of claim 1, wherein the stabilizing network comprises silicon stabilized by oxygen.

4. The carbon material of claim 1, comprising at least one alloying element selected from the group consisting of hydrogen, oxygen, and silicon.

5. The carbon material of claim 1, wherein the carbon material has a density of about 1.1 1.7 g/cm³ to about 1.7 g/cm³.

6. The carbon material of claim 1, comprising at least 10% diamond-like bonded carbon of a total carbon content and at least 5% polymer-like bonded carbon of the total carbon content.

7. The carbon material of claim 1, comprising at least 25% diamond-like bonded carbon of a total carbon content and at least 15% polymer-like bonded carbon of the total carbon content.

8. The carbon material of claim 1, wherein the carbon material exhibits a dielectric constant of no more than about 5.0.

9. The carbon material of claim 1, wherein the carbon material exhibits a hardness of at least 10 GPa.

10. The carbon material of claim 1, wherein the carbon material exhibits an elastic modulus of at least 50 GPa.

11. The carbon material of claim 1, wherein the carbon material is at least partially amorphous.

12. The carbon material of claim 1, wherein the carbon material comprises carbon at an amount of at least about 25 atomic % of a sum of the carbon and the alloying elements therein.

13. The carbon material of claim 1, wherein the carbon material comprises carbon at an amount of at least about 33 atomic % of a sum of the carbon and the alloying elements therein.

14. The carbon material of claim 1, wherein the carbon material comprises carbon at an amount of about 67 atomic % to about 75 atomic % of a sum of the carbon and the alloying elements therein.

15. The carbon material of claim 1, comprising hydrogen at an amount of at least about 10 atomic % of the carbon therein.

16. The carbon material of claim 1, comprising hydrogen at an amount of at least about 50 atomic % of the carbon therein.

17. The carbon material of claim 1, wherein the carbon material is produced by depositing constituent elements on a substrate using a deposition technique that produces a flow of constituent elements, including carbon, in a form of at least one of ions, atoms, and radicals, wherein at least 55 atomic % of carbon in the flow has an energy in the range of from about 10 eV to about 95 eV, and wherein the substrate is maintained at a temperature less than 300 degrees C.

18. An atomic scale composite carbon material comprising a polymer-like bonded carbon network, a diamond-like bonded carbon network, and a graphene-like bonded carbon network, hydrogen, and at least one stabilizing network of at least one alloying element, wherein the carbon networks interpenetrate each other and are partially inter-bonded, and wherein the material comprises at least 10% diamond-like bonded carbon and at least 5% polymer-like bonded carbon.

19. A method for producing an atomic scale composite carbon material comprising depositing on a substrate constituent elements using a deposition technique that provides a flow of constituent elements, including carbon, in a form of at least one of ions, atoms, and radicals, wherein at least 55 atomic % of carbon in the flow has an energy in the range of from about 10 eV to about 95 eV, and maintaining the substrate at a temperature less than 300 degrees C. during deposition.

20. The method of claim 19, wherein the carbon material is deposited using a remote plasma generator while maintaining pressure in a deposition chamber at a level of no greater than about 1 millitorr.

21. The method of claim 19, wherein the carbon material comprises carbon, silicon, oxygen, and hydrogen constituent elements, that are derived from a polysiloxane precursor for the constituent elements.

22. The method of claim 21, wherein the polysiloxane is supplied as a liquid and vaporized in a plasma generator.

23. The method of claim 19, wherein the carbon material comprises a plurality of interpenetrating carbon networks comprising a polymer-like bonded carbon network, a diamond-like bonded carbon network, a graphene-like bonded carbon network, and at least one stabilizing network of at least one alloying element.
